(19) United States
(12) Patent Application Publication
(10) Pub. No.: US 2009/0317719 A1
(43) Pub. Date: Dec. 24, 2009

(54) Material With Core-Shell Structure

(75) Inventors: Claudia Luhrs, Rio Rancho, NM (US); Jonathan Phillips, Rio Rancho, NM (US); Monique N. Richard, Ann Arbor, MI (US); Kimber L. Stamm, Ann Arbor, MI (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); The University of New Mexico, Albuquerque (MX)

(21) Appl. No.: 12/142,933

(22) Filed: Jun. 20, 2008

(51) Int. Cl. H01M 4/38; B32B 15/04

(52) U.S. Cl. 429/218.1; 428/403; 977/775

(57) ABSTRACT

Disclosed is a material having a composite particle. The composite particle includes an outer shell containing an element such as carbon, nitrogen, oxygen or sulfur and an inner core made from a lithium alloying material such as tin, silicon, aluminum and/or germanium. If the outer shell is made from carbon, the outer shell of the composite particle has an average thickness of less than 20 nanometers and the composite particle has an outer mean diameter of less than 100 nanometers. In some instances, the inner core is made from tin, a tin binary alloy, a tin tertiary alloy or a tin quaternary alloy.

### GOVERNMENT INTEREST

This invention was made with government support under Contract No. DE-AC52-06NA25396 awarded by the U.S. Department of Energy. The government has certain rights in the invention.

### FIELD OF THE INVENTION

The present invention relates to a material, in particular to a material having a core-shell structure.

### BACKGROUND OF THE INVENTION

The energy requirements for batteries are continually increasing, while constraints on volume and mass continue to be present. Further, the demand for safe, low cost and environmentally friendly materials is increasing. These demands and battery specifications cannot be met using traditional lithium-ion battery chemistries. Although lithium-ion batteries have long been optimized and have demonstrated stable energies, these systems are limited by the amount of lithium that can be reversibly inserted and removed from the battery's active material structure.

The requirements for greater performance, safety, low cost and environmentally friendly materials can only be achieved through the development of new battery materials. Researchers have proposed the replacement of the carbon-based anode with tin. Tin alloys with lithium during the charging of the battery. The lithium-tin alloy forms a maximum concentration of 4.4 lithium atoms per tin atom, a concentration which equals a capacity of 993 mAh/g. A traditional carbon-based anode has a theoretical capacity of 372 mAh/g. Therefore, the replacement of traditional carbon-based anode batteries with tin-based anode batteries could result in higher energy capabilities.

Research has demonstrated that there are two main issues with the use of a tin-based anode. The first is a poor cycle life and the second is a poor utilization of the tin. A poor cycle life is defined as poor retention of battery energy as a function of the number of charge-discharge cycles. Researchers have taken two approaches to solving these problems. First, by forming an intermetallic compound of tin and at least one other metal, and second, by adding a non-electrochemically active material to the anode composite. However, the prior research has failed to address the fundamental causes of the poor performance of lithium-tin batteries, which are: 1) a large volume expansion of the tin-lithium particles resulting from the alloying of lithium with tin on charge; and 2) the breaking apart of tin agglomerates during the above-stated volume expansion. The volume expansion results in separation of the tin particles from the matrix during subsequent cycles and breaking of tin agglomerates results in fine particles with exposed fresh surface area. This fresh surface area is not in contact with the matrix, and thus like the separation of tin particles from the matrix, results in decrease in battery capacity. Therefore, there is a need for a lithium-tin battery that exhibits adequate cycle life and proper utilization of the tin.

### SUMMARY OF THE INVENTION

Disclosed is a material having a composite particle. The composite particle includes an outer shell containing an element such as carbon, nitrogen, oxygen or sulfur and an inner core made from a lithium alloying material such as tin, silicon, aluminum and/or germanium. If the outer shell is made from carbon, the outer shell of the composite particle has an average thickness of less than 20 nanometers and the composite particle has an outer mean diameter of less than 100 nanometers. In some instances, the inner core is made from tin, a tin binary alloy, a tin tertiary alloy or a tin quaternary alloy.

### BRIEF DESCRIPTION OF THE DRAWINGS

FIG. 1 is a schematic cross-sectional view of a material according to an embodiment of the present invention;

FIG. 2 is a flow diagram illustrating a method for producing an embodiment of the present invention;

FIG. 3 is a transmission electron microscopy image of a carbon outer shell having a tin core.

### DETAILED DESCRIPTION OF THE INVENTION

The present invention includes a material made from a composite particle, the composite particle having an outer shell and an inner core. The inner core is made from a lithium alloying material and the outer shell is an electronic conductor, an ionic conductor and/or a mixed conductor. The shell may or may not reversibly react with lithium to provide extra energy during battery operation. It is appreciated that if the shell does reversibly react with lithium, it can provide a safety buffer with respect to overcharging by preventing lithium from plating on the anode surface. As such, the material has utility for use in an electrochemical device.

In some instances, the core is solid during the use of the material. For example, the inner core can be made from a lithium alloying material, illustratively including tin, a binary tin alloy, a ternary tin alloy and the like. It is appreciated that a plurality of composite particles can be assembled to make an electrode, the electrode being part of an electrochemical device.

A method is also disclosed for producing the composite particle. The method includes providing a precursor powder having components of the outer shell and the inner core. The powders of the precursor material are suspended in a gas to form an aerosol and the aerosol is then passed through a hot zone of a plasma torch. Passing the precursor powders through the plasma torch produces a core-shell composite particle wherein the core occupies generally 100% of an inner volume of the outer shell.

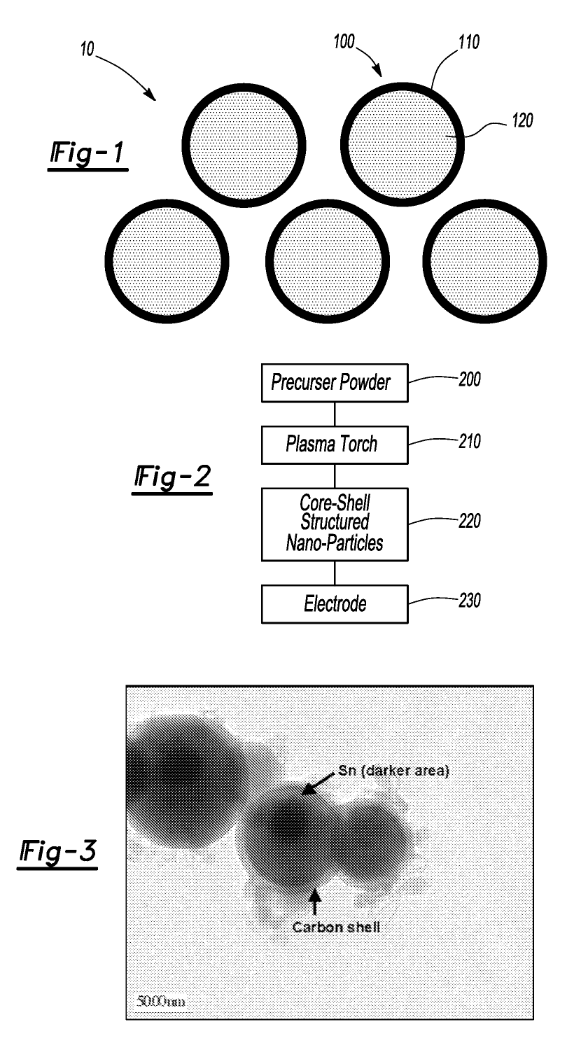

Turning now to FIG. 1, a material made from a composite particle according to an embodiment of the present invention is shown generally at reference numeral 10. The material 10 includes a composite particle 100, the particle 100 having an outer shell 110 and an inner core 120. It is appreciated that the inner core 120 can include two separate volumes—a first volume of the core material and a second volume of void space. In the alternative, the inner core 120 can include only one volume of the core material.

The inner core 120 can be made from a lithium alloying material, illustratively including tin, silicon, aluminum, germanium, combinations thereof and alloys thereof. The outer shell 110 can also be made from a variety of materials. For example, materials such as oxides, carbonates, halides, carbides, graphite, graphene, anthracene and amorphous carbon can be used to form the outer shell of a composite particle so long as the resulting outer shell is an electronic conductor, an ionic conductor, and/or a mixed conductor.

The outer mean diameter of the composite particle 100 is less than 1000 nanometers and in some instances can be less than 500 nanometers, or in the alternative, be less than 100 nanometers. If the outer shell 110 is made from carbon, then the outer diameter is less than 100 nanometers. In other instances, the outer mean diameter of the composite particle 100 is less than 70 nanometers while in still yet other instances the outer mean diameter is less than 50 nanometers. The average wall thickness of the outer shell 110 is less than 200 nanometers and in some instances can be less than 100 nanometers, or in the alternative, be less than 20 nanometers. If the outer shell 110 is made from carbon, then the outer diameter is less than 20 nanometers.

A method for producing the material disclosed herein is illustratively shown in FIG. 2. The method includes providing a precursor powder containing materials that at least partially constitute the outer shell and inner core at step 200 and passing the precursor powder through a plasma torch at step 210. Upon passing the precursor powder through the plasma torch at step 210, a core-shell power is produced at step 220, for example a plurality of composite particles 100 illustrated in FIG. 1. If so desired, an electrode can be made from the composite particles produced at step 220 at step 230. It is appreciated that the composite particle 100 can be made such that the inner core 120 is a lithium alloying material that is prelithiated, that is, the inner core 120 is made from material that it has already been alloyed with lithium upon formation of the composite particle 100.

In order to better illustrate the embodiments described above, an example of a composite particle and a method of manufacture is provided.

### EXAMPLE

In an attempt to produce a carbon shell-tin core composite particle, a dry precursor powder was prepared having a tin to anthracene ratio of 50:1. It is appreciated that other aromatic coke forming compounds such as naphthalene or acenaphthalene can be used for providing the carbon material. The precursor powder was suspended in an argon gas, thereby producing an aerosol gas of argon with anthracene and tin. The aerosol gas was passed through a low power atmospheric or near atmospheric pressure plasma with microwave energy focused within a coupler. It is appreciated that plasmas generated using other methods can also be used. In addition to the aerosol gas, a second supply of argon gas was passed through the plasma area.

Not being bound by theory, the inventors postulate that upon passing through the plasma hot zone, the carbon within the precursor powder undergoes a carbonization mechanism forming carbon fragments. In addition, the tin within the precursor powder melts and upon cooling forms particles via a nucleation process. The carbon fragments collect on the same nuclei as the tin and based on relative miscibility segregate to the nuclei surface. The nucleating particles exit from the hot zone into an afterglow region in which no further growth occurs.

FIG. 3 shows a transmission electron microscopy image wherein a composite particle having a carbon outer shell and a tin core was produced using the anthracene-tin precursor powder, an argon aerosol gas flow rate of 300 cubic centimeters per minute (cc/min), an argon plasma gas flow rate of 200 cc/min and a forwarded microwave power of 900 watts. As shown in this figure, composite particles having an outer mean diameter of between 50 to 100 nanometers were produced with a carbon outer shell and a tin core. At this step of the process, the tin core essentially occupies all of the inner volume within the carbon outer shell.

It is appreciated that the example given above is for illustrative purposes only and other methods are included that produce a composite particle having an outer shell with a core, the core being of reduced size such that expansion of the core can occur within the outer shell without failure of said outer shell.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

We claim:

1. A material comprising:
a composite particle having an outer shell containing an element selected from the group consisting of nitrogen, oxygen and sulfur, and an inner core made from a lithium alloying material containing an element selected from the group consisting of tin, silicon, aluminum and germanium;
said composite particle having an outer mean diameter of less than 1000 nanometers.

2. The material of claim 1, further comprising an outer shell made from carbon, said composite particle having an outer diameter of less than 100 nanometers.

3. The material of claim 2, wherein said outer shell has an average thickness of less than 20 nanometers.

4. The material of claim 3, wherein said composite particle has an outer mean diameter of less than 70 nanometers.

5. The material of claim 3, wherein said composite particle has an outer mean diameter of less than 50 nanometers.

6. The material of claim 1, wherein said inner core is made from a lithium alloying material selected from the group consisting of tin, a tin binary alloy, a tin tertiary alloy and a tin quaternary alloy.

7. An anode for a lithium battery, said anode comprising:
a composite particle having an outer shell containing an element selected from the group consisting of nitrogen, oxygen and sulfur, and an inner core made from a lithium alloying material containing an element selected from the group consisting of tin, silicon, aluminum and germanium;
said composite particle having an outer mean diameter of less than 1000 nanometers.

8. The material of claim 7, further comprising an outer shell made from carbon, said composite particle having an outer diameter of less than 100 nanometers.

9. The anode of claim 8, wherein said outer shell of said composite particle has an average thickness of less than 20 nanometers.

10. The anode of claim 9, wherein said composite particle has an outer mean diameter of less than 70 nanometers.

11. The anode of claim 10, wherein said composite particle has an outer mean diameter of less than 50 nanometers.

12. The anode of claim 7, wherein said inner core is made from a lithium alloying material selected from the group consisting of tin, a tin binary alloy, a tin tertiary alloy and a tin quaternary alloy.

13. The anode of claim 7, further comprising a binder.

14. An anode for a lithium battery, said anode comprising:
a composite particle having an outer shell containing an element selected from the group consisting of carbon, nitrogen, oxygen and sulfur, and an inner core made from a lithium alloying material containing an element selected from the group consisting of tin, silicon, aluminum and germanium;
said composite particle having an outer mean diameter of less than 100 nanometers and said outer shell having an average thickness of less than 20 nanometers.

15. The anode of claim 14, wherein said composite particle has an outer mean diameter of less than 70 nanometers.

16. The anode of claim 15, wherein said composite particle has an outer mean diameter of less than 50 nanometers.

17. The anode of claim 14, wherein said outer shell is carbon.

18. The anode of claim 14, wherein said inner core is made from a lithium alloying material selected from the group consisting of tin, a tin binary alloy, a tin tertiary alloy and a tin quaternary alloy.

19. The anode of claim 14, further comprising a binder.
